(19) United States
(12) Patent Application Publication
(10) Pub. No.: US 2007/0127009 A1
(43) Pub. Date: Jun. 7, 2007

(54) Multi-modulation frequency laser range finder and method for the same

(76) Inventors: Su-Ling Chen, Taipei City (TW); Yi-Ting Kuo, Hsinchu City (TW); Mang Ou-Yang, Hsinchu City (TW); June-Wen Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/295,572

(22) Filed: Dec. 7, 2005

(51) Int. Cl. G01C 3/08

(52) U.S. Cl. 356/5.1

(57) ABSTRACT

A multi-modulation frequency laser range finder and a method for the same make use of a crystal oscillator to send out a modulation signal and a sampling signal. After the modulation signal is coupled with a light signal emitted by a laser diode, a laser light beam is generated and emitted to a target. The laser light signal is reflected by the target and received by a receiver to be converted to a reception signal, which is processed according to the frequency of the sampling signal. The processed result is finally sent to a data processor to calculate out the distance to the target. As compared to the prior art, less number of components are used, the precision is enhanced, and the circuit is much simplified, hence reducing the errors and the cost.

### BACKGROUND OF THE INVENTION

1. Field of the Invention

The present invention relates to a range finder and a measurement method for the same and, more particularly, to a multi-modulation frequency laser range finder and a method for the same.

2. Description of Related Art

Laser ranging methods can be classified into three categories: the time of flight measurement method, the phase-shift measurement method, and the triangulation method. The phase-shift measurement makes use of a laser light to illuminate a distant target, and the reflected light is received by a detector to produce an electric signal. The phase difference between this electric signal and a reference signal is calculated to obtain the distance to the target. Because phase is periodic with a modulo of 2π, the phase-shift measurement method is limited in the measurement of distance. The range of measurement is about several tens of meters, and the precision is about in the order of millimeter.

FIG. 1 is a block diagram of a laser ranging device in the prior art. As shown in FIG. 1, there are two frequency generators: a radio-frequency (RF) oscillator 40 and a local oscillator 42 respectively generating an RF frequency f_{RF} and a local frequency f_{LO}. A signal of the RF frequency f_{RF} drives a laser diode 44 to produce a modulated laser light beam emitted to a target 46. The beam is reflected by the target 46 and then received by a detector 48 to be converted to an electric signal. The electric signal is mixed with the local frequency signal f_{LO} by a balance mixer 50 to generate a ranging signal V₂(t) of an intermediate frequency f_{IN}. Another signal of the RF frequency is directly mixed with a signal of the local frequency f_{LO} to produce a reference signal V₁(t) of an intermediate frequency f_{IN}. V₁(t) and V₂(t) respectively pass a first phase lock loop (PLL) 52 and a second PLL 54 of the same architecture. Because the PLLs 52 and 54 has the functions of locking phase and dividing frequency, the phase difference of these two signals can be output by a phase meter 56 to be N times of the original phase difference. Although this device has a high ranging precision, because the modulation frequency is fixed, the measured range will be fixed. Moreover, because two PLLs and two mixers are used in the circuit, the circuit is more complicated and has larger errors.

FIG. 2 is a block diagram of another laser ranging device in the prior art. As shown in FIG. 2, a quartz oscillator 58 produces a low frequency signal for wide-range measurement, a high frequency signal for high precision, an intermediate frequency signal for mixing, and a sampling signal for digitalizing the signal. A laser light is coupled with the high modulation frequency signal and then emitted to a target. The reflected laser light is received by a receiver and then demodulated to get an electric signal. This electric signal is mixed with the intermediate frequency signal and is then sampled. The low modulation frequency signal is similarly used to get a detection signal, but is directly sampled without being mixed with the intermediate frequency signal. The above obtained phase includes the phase generated by the circuit itself, which can be obtained through direct sampling of signal. Because this device only provides a fixed modulation frequency, the measured range and precision will be fixed. Moreover, because five transfer switches and a mixer are required in the circuit, the manufacturing is complicated and the measurement errors increase.

Accordingly, the present invention aims to propose a multi-modulation frequency laser range finder and a method for the same to solve the above problems in the prior art effectively.

### SUMMARY OF THE INVENTION

An object of the present invention is to provide a multi-modulation frequency laser range finder and a method for the same, in which a single PLL is used to accomplish a modulation frequency with multiple choices and the sampling frequency is fixed. A user can therefore select two appropriate modulation frequencies according to the distance to be measured to obtain the maximal measured distance and the required precision.

Another object of the present invention is to provide a multi-modulation frequency laser range finder and a method for the same, which makes use of a more simplified circuit design as compared to the prior art to lower both the cost and the errors.

Another object of the present invention is to provide a multi-modulation frequency laser range finder and a method for the same, which makes use of a programmable PLL to adjust the modulation signal so as to change the measured range and precision.

Another object of the present invention is to make use of the under sampling theory so that the sampling frequency won't change due to differences of high, low or intermediate frequency signals, thereby getting rid of the requirement of any frequency mixer.

Another object of the present invention is to provide a multi-modulation frequency laser range finder and a method for the same, which can apply to various non-contact distance measurements such as height measurement of building, object positioning, ranging in golf field, and robot ranging. If the device is manufactured into a scanning type, three-dimensional distance images can be produced.

To achieve the above objects, the present invention provides a multi-modulation frequency laser range finder and a method for the same, which make use of a crystal oscillator to provide a modulation signal and a sampling signal. The modulation signal can be transmitted to a programmable PLL to control the frequency of the modulation signal. The frequency of the sampling signal is reduced by a divider. A light signal of a laser diode is coupled with the modulation signal to emit a laser light beam to a target. The beam is reflected by the target and then received and demodulated by a receiver into a reception signal. The reception signal is transmitted to an analog-to-digital converter for processing. The reception signal is sampled according to the frequency of the sampling signal. The sampled result is sent to a data processor to calculate out the distance between the laser diode and the target. As compared to the prior art, the present invention has simpler components. Moreover, the modulation signal can be adjusted by the programmable PLL to select an appropriate operating frequency according to user's necessity.

### BRIEF DESCRIPTION OF THE DRAWINGS

The various objects and advantages of the present invention will be more readily understood from the following detailed description when read in conjunction with the appended drawing, in which:

FIG. 1 is a block diagram of a laser ranging device in the prior art;

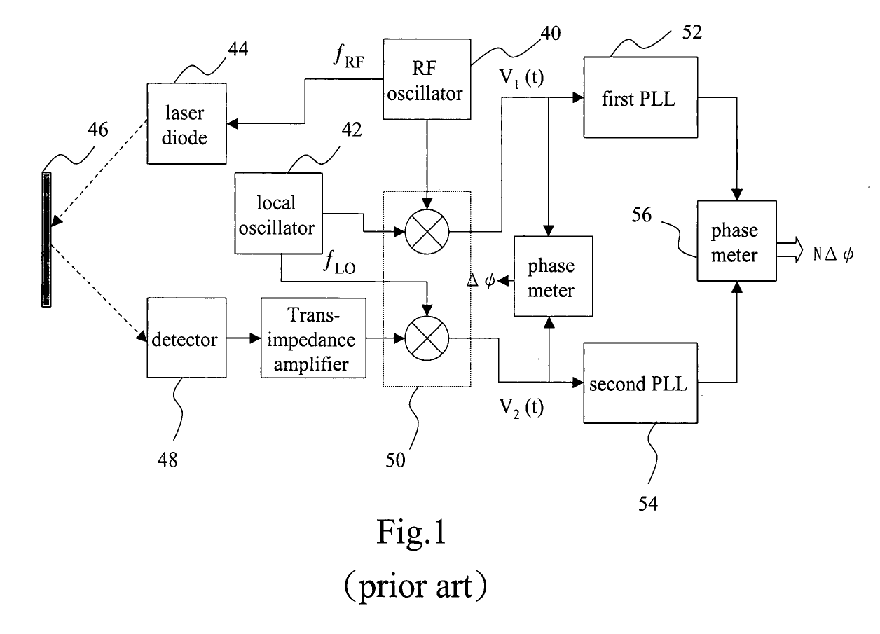

FIG. 2 is a block diagram of another laser ranging device in the prior art;

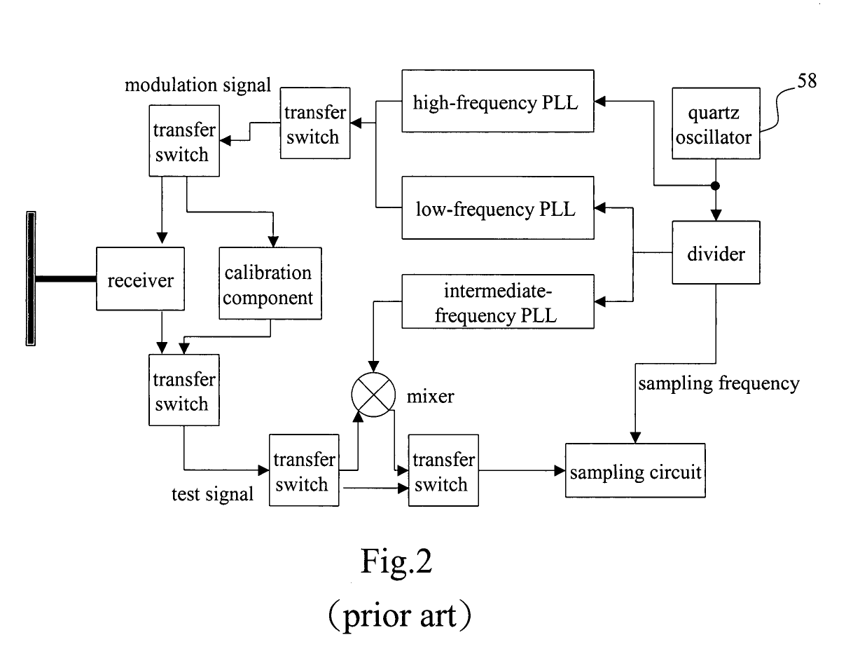

FIG. 3 is a block diagram of the present invention; and

FIG. 4 is a calculation flowchart of the data processor of the present invention.

### DETAILED DESCRIPTION OF THE PREFERRED EMBODIMENTS

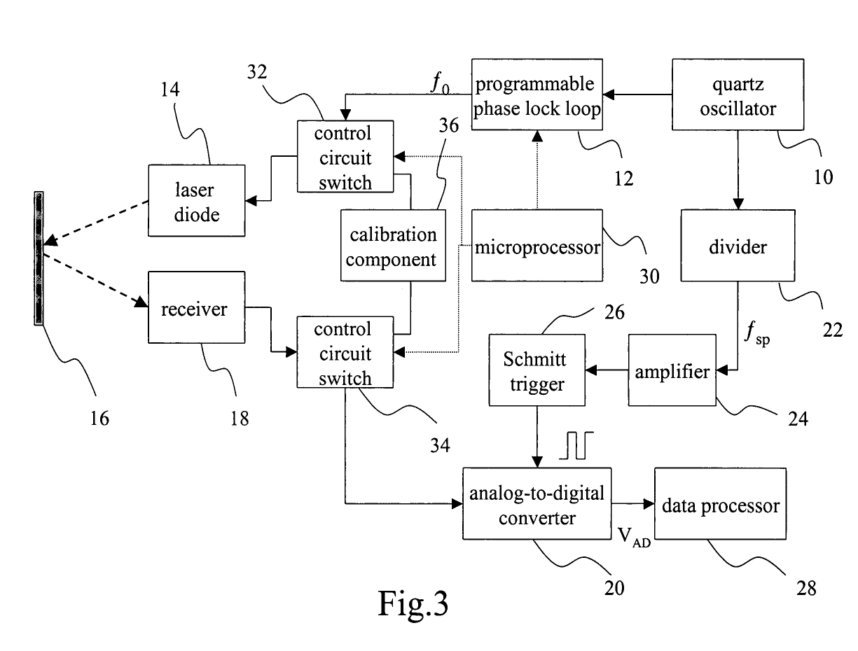

FIG. 3 is a block diagram of the present invention. As shown in FIG. 3, a quartz oscillator 10 is used as a frequency generator, which sends out a modulation signal and a sampling signal and ensures initial phases of these two signals are locked. The modulation signal passes a programmable PLL 12 to have a frequency f₀. The sampling signal passes a divider 22 to get a lower sampling frequency fₛₚ. The modulation signal then passes a circuit switch 32. Because the circuit switch has not been activated yet, the modulation signal is immediately sent to a laser diode 14 without any change. The modulation signal drives the laser diode 14 to produce a laser light beam emitted to a target 16.

This beam is reflected by the target 16 and then received by an optical receiver (not shown) in a receiver 18. The receiver 18 demodulates the laser light beam into a reception signal. Next, the reception signal is transmitted by a non-activated circuit switch 34 to an analog-to-digital converter 20. The sampling signal with the sampling frequency fₛₚ first passes an amplifier 24 and a Schmitt trigger 26 to get a better sampling pulse, and is then transmitted to the analog-to-digital converter 20. The reception signal is sampled in the analog-to-digital converter 20 according to the frequency fₛₚ of the sampling signal to get a V_{AD} digital signal. The sampled result is subsequently sent to a data processor 28 for further processing.

In order to get the phase shift caused by the circuit itself and make correction, a microprocessor 30 and a calibration component 36 can be used to control the circuit switches 32 and 34 so that the modulation signal is directly sent to the analog-to-digital converter 20 after passing the calibration component 36 and is then sampled using the same sampling frequency, thereby obtaining another V_{AD} digital signal. The data processor 28 can thus subtract the phase shift caused by the circuit itself.

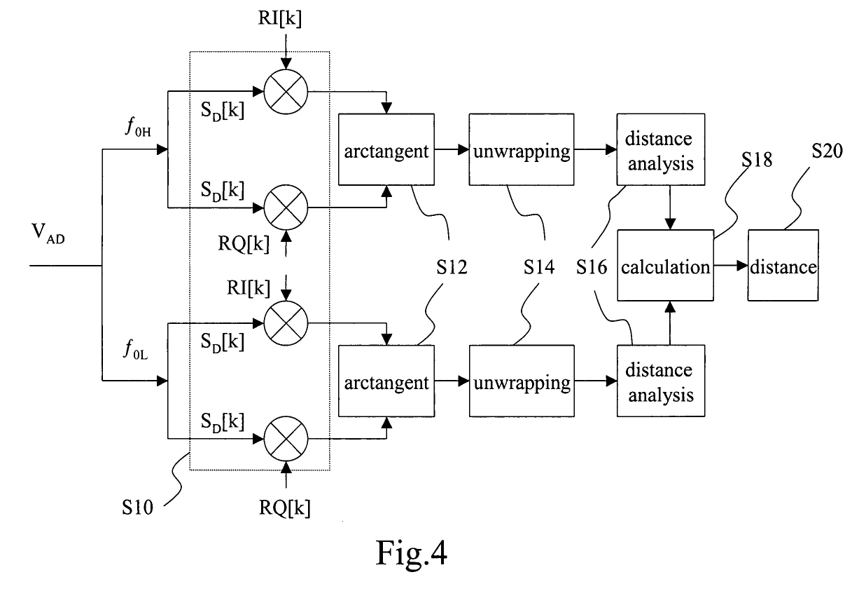

The data processing process in the data processor 28 is shown in FIG. 4. The modulation signals with the high modulation frequency f_{0H} and the low modulation frequency f_{0L} and the sampling signal S_{D}[k] are multiplied by RI[k] and RQ[k] generated by the program, respectively (Step S10). The frequency of the modulation signal can be controlled by the programmable PLL 12 to be high or low. Next, arctangent operations are performed to let the range of function be within −π/2˜π/2 (Step S12). Phase unwrapping is then performed to convert the phase into the range of 0˜2π (Step S14). Subsequently, the distance and the resolution are obtained (Steps S16 to S20). Finally, a high-precision distance is acquired through scale combination calculation. The distance calculation steps by means of phase are illustrated below. The laser light beam emitted by the laser diode is received by the receiver. In view of phase, phase change will surely occur in this process, which can be expressed as:
φ=2 πf₀t_{d}=2 πf₀(2d/c) (1)
where f₀ is the modulation frequency, t_{d} is the light travel time, d is the distance, and c is the light speed.

Therefore, the distance between the receiver and the target is:
d=(c/2f₀)(φ/2 π) (2)

Because the phase repeats every 2π, the maximal measured range (or called non-ambiguity range (NAR)) can be obtained from (2):
NAR=c/2f₀ (3)

Both sides of (2) are differentiated to get the resolution:
δ d/δ φ=c/4 πf₀ (4)

The light wave emitted by the laser diode that is modulated by the frequency f₀ and the reception signal can be respectively expressed as:
s_{E}(t)=Ŝ_{E}[a_{E}+cos(2 πf₀t)] (5)
s_{D}(t)=Ŝ_{D}[a+cos(2 πf₀t+Ψ_{d}+φₑ)] (6)
where Ψ_{d} is the phase shift generated during light propagation, φₑ is the phase shift generated by the modulation signal in the instrument, Ŝ_{E} and Ŝ_{D} are the amplitude of the emission and reception light wave, respectively. Because the two signals have no negative values, a DC term a_{E} and a is added in the formulas.

The under sampling technique is then exploited. If f_{SP} is the sampling frequency and nf_{SP} is the frequency closest to f₀, the reception signal after sampling can be expressed as:
s_{D}[k]=Ŝ_{D}[a+cos(2 πf₀kT_{SP}+Ψ_{d}+φₑ)] (7)
where T_{SP}=1/f_{SP} and k is an integer. The synchronous signals RI[k]=sin(2 πf_{AL}kT_{SP}) and RQ[k]=cos(2πf_{AL}kT_{SP}) with the frequency f_{AL}=f₀−nf_{SP} are multiplied by the reception signal S_{D}[k] to get new signals MI[k] and MQ[k]. If 2 πf_{AL}kT_{SP}=k π/2, then f_{SP}=4 f₀/(4n+1), RI[k]=sin(k π/2), RQ[k]=cos(k π/2), where f_{SP}=4 f₀/(4n+1) can be acquired by adjusting the frequency f₀ of the modulation signal. That is, when the sampling frequency and the modulation frequency are related as above, MI[k] and MQ[k] can be respectively expressed as:

$$\begin{matrix}\begin{matrix}MI [ k ] = {s}_{D} [ k ] \times RI [ k ] \\ = \{ a + cos [ 2 π {f}_{0} {kT}_{SP} + ( {Ψ}_{d} + {ϕ}_{e} ) ] \} sin ( k π / 2 ) \\ = 1 / 2 \{ cos [ ( 2 n + 1 ) k π ] sin ( {Ψ}_{d} + {ϕ}_{e} ) - sin ( {Ψ}_{d} + {ϕ}_{e} ) \} + \\ a \times sin ( k π / 2 )\end{matrix} & ( 8 ) \\ \begin{matrix}MQ [ k ] = {s}_{D} [ k ] \times RQ [ k ] \\ = \{ a + cos [ 2 π {f}_{0} {kT}_{SP} + ( {Ψ}_{d} + {ϕ}_{e} ) ] \} cos ( k π / 2 ) \\ = 1 / 2 \{ cos [ ( 2 n + 1 ) k π ] cos ( {Ψ}_{d} + {ϕ}_{e} ) + cos ( {Ψ}_{d} + {ϕ}_{e} ) \} + \\ a \times cos ( k π / 2 )\end{matrix} & ( 9 )\end{matrix}$$

Every four consecutive k values are grouped together. When k is odd, MI[k] are averaged to get Ave(MI[k]). When k is even, MQ[k] are averaged to get Ave(MQ[k]). Table 1 shows the values of MI[k] and MQ[k] for k=0˜3:

TABLE 1

| k | MI[k] | MQ[k] |
|---|---|---|
| 0 | 0 | a + cos(Ψ_{d} + φₑ) |
| 1 | a − sin(Ψ_{d} + φₑ) | 0 |
| 2 | 0 | −a + cos(Ψ_{d} + φₑ) |
| 3 | −a − sin(Ψ_{d} + φₑ) | 0 |

The phase can be obtained from the following formula with simultaneous elimination of the DC term a:
Ψ_{d}+φₑ=tan⁻¹[−Ave(MI[k])/Ave(MQ[k])] (10)

Because the value of an arctangent function tan⁻¹ is defined between −π/2 and π/2, the phase obtained by the formula (10) is also within the range between −π/2 and π/2. The signs of the numerator and the denominator of the arctangent function correspond to the signs of sin φ and cos φ, respectively. Because both sine and cosine are continuous functions with a modulo of 2π, the quadrant where the phase belongs can be determined according to the signs of the numerator and the denominator of the arctangent function. Table 2 is used to unwrap the phase to the range between 0 and 2π. This technique is called phase unwrapping.

TABLE 2

| | co- | Correct | Phase | | co- | Correct | Phase |
|---|---|---|---|---|---|---|---|
| sine | sine | phase Ψ_{d} | range | sine | sine | phase Ψ_{d} | range |
| 0 | + | 0 | 0 | 0 | − | π | π |
| + | + | Ψ_{d} | 0˜π/2 | − | − | Ψ_{d} + π | π˜3π/2 |
| + | 0 | π/2 | π/2 | − | 0 | 3π/2 | 3π/2 |
| + | − | Ψ_{d} + π | π/2˜π | − | + | Ψ_{d} + 2π | 3π/2˜2π |

If the distance between the receiver and the target is 0, φₑ can be obtained in the same way. The formula (10) is subtracted by φₑ to get the phase shift, and the formula (2) is then used to obtain the distance. When the frequency f₀ is high, the measured range is small but the resolution is high; when the frequency f₀ is low, the measured range is large but the resolution is low.

To sum up, the present invention proposes a multi-modulation frequency laser range finder and a method for the same, in which the sampling frequency is fixed, and a programmable PLL is used to adjust the frequency of the modulation signal, thereby accomplishing a modulation frequency with multiple choices. Users can select two appropriate frequencies based on the distance to be measured to acquire the actual distance after calculation. Moreover, the circuit of the present invention is more simplified as compared to the prior art. Only one PLL and two transfer switches are required, and it is not necessary to use any mixer. The errors and the cost can thus be greatly reduced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multi-modulation frequency laser range finder comprising:
a crystal oscillator for providing a modulation signal and a sampling signal;
a laser diode for generating a laser light beam coupled with said modulation signal and then emitting a laser light beam to a target;
a receiver for receiving said laser light beam reflected by said target and demodulating said laser light beam to a reception signal; and
a data processor for processing said reception signal according to the frequency of said sampling signal and calculating out a distance to said target.

2. The multi-modulation frequency laser range finder as claimed in claim 1, wherein said crystal oscillator can ensure that initial phases of said modulation signal and said sampling signal be locked.

3. The multi-modulation frequency laser range finder as claimed in claim 1, wherein the frequency of said modulation signal is controlled by using a programmable PLL.

4. The multi-modulation frequency laser range finder as claimed in claim 1, wherein the frequency of said sampling signal can be lowered after passing a divider.

5. The multi-modulation frequency laser range finder as claimed in claim 1, wherein said reception signal first passes an analog-to-digital converter before being transmitted to said data processor.

6. The multi-modulation frequency laser range finder as claimed in claim 5, wherein said sampling signal is first processed by an amplifier and a Schmitt trigger to get a better sampling pulse and then transmitted to said analog-to-digital converter.

7. The multi-modulation frequency laser range finder as claimed in claim 5, wherein said sampling signal is obtained by means of under sampling, and is transmitted to said analog-to-digital converter.

8. The multi-modulation frequency laser range finder as claimed in claim 5, wherein when a microprocessor adjusts a plurality of circuit switches, said modulation signal passes said programmable PLL and is then directly transmitted to said analog-to-digital converter.

9. The multi-modulation frequency laser range finder as claimed in claim 1, wherein said crystal oscillator is a quartz oscillator, an RC oscillator, or any oscillator capable of generating an oscillation source.

10. A multi-modulation frequency laser ranging method comprising the steps of:
using a crystal oscillator to generate a modulation signal and a sampling signal;
modulating said modulation signal and then coupling said modulation signal with a light signal of a laser diode to product a laser light beam that is emitted to a target;
using a receiver to receive said laser light beam reflected by said target and demodulate said laser light beam to a reception signal; and
processing said reception signal according to the frequency of said sampling signal and transmitting the result to a data processor to calculate out a distance to said target.

11. The multi-modulation frequency laser ranging method as claimed in claim 10, wherein said crystal oscillator can ensure that initial phases of said modulation signal and said sampling signal be locked.

12. The multi-modulation frequency laser ranging method as claimed in claim 10, wherein the frequency of said sampling signal can be lowered after passing a divider.

13. The multi-modulation frequency laser ranging method as claimed in claim 10, wherein the frequency of said modulation signal is controlled by using a programmable PLL before passing said laser diode.

14. The multi-modulation frequency laser ranging method as claimed in claim 10, wherein said reception signal first passes an analog-to-digital converter before being transmitted to said data processor.

15. The multi-modulation frequency laser ranging method as claimed in claim 14, wherein said sampling signal is first processed by an amplifier and a Schmitt trigger to get a better sampling pulse and then transmitted to said analog-to-digital converter.

16. The multi-modulation frequency laser ranging method as claimed in claim 14, wherein said sampling signal is obtained by means of under sampling, and is transmitted to said analog-to-digital converter.

17. The multi-modulation frequency laser ranging method as claimed in claim 14, wherein when a microprocessor adjusts a plurality of circuit switches, said modulation signal passes said programmable PLL and is then directly transmitted to said analog-to-digital converter.

18. The multi-modulation frequency laser ranging method as claimed in claim 10, wherein said crystal oscillator is a quartz oscillator, an RC oscillator, or any oscillator capable of generating an oscillation source.
